(19) United States
(12) Patent Application Publication
(10) Pub. No.: US 2026/0141915 A1
(43) Pub. Date: May 21, 2026

(54) DIALOG SUPPORT METHOD, INFORMATION PROCESSING DEVICE, AND NON-TRANSITORY STORAGE MEDIUM

(71) Applicant: Toyota Jidosha Kabushiki Kaisha, Toyota-shi (JP)

(72) Inventor: Takuma SUZUKI, Tokyo (JP)

(73) Assignee: Toyota Jidosha Kabushiki Kaisha, Toyota-shi (JP)

(21) Appl. No.: 19/360,346

(22) Filed: Oct. 16, 2025

(30) Foreign Application Priority Data
Nov. 15, 2024 (JP) 2024-200026

(51) Int. Cl. G10L 25/54; G06F 16/3329; G06F 16/3332; G06Q 10/10; G06Q 30/015; G10L 15/22

(52) U.S. Cl. CPC G10L 25/54; G06F 16/33295; G06F 16/3332; G06Q 10/10; G06Q 30/015; G10L 15/22

(57) ABSTRACT

A dialog support method to be executed by an information processing device includes determining a topic based on speech data regarding a predetermined thing and a database regarding the predetermined thing, extracting a question sentence from the speech data and generating a supplemental question sentence based on the question sentence and the topic during a period while the question sentence has been extracted, and outputting a response to the supplemental question sentence.

### CROSS-REFERENCE TO RELATED APPLICATION

This application claims priority to Japanese Patent Application No. 2024-200026 filed on Nov. 15, 2024. The disclosure of the above-identified application, including the specification, drawings, and claims, is incorporated by reference herein in its entirety.

### BACKGROUND

### 1. Technical Field

The present disclosure relates to a dialog support method, an information processing device, and a non-transitory storage medium.

### 2. Description of Related Art

A technique of analyzing content of a business meeting is known. For example, Japanese Unexamined Patent Application Publication No. 2019-28910 (JP 2019-28910 A) discloses a dialog analysis system that checks whether a sales person explains matters that should be explained and does not state matters that should not be stated in a business meeting with a customer.

### SUMMARY

While JP 2019-28910 A discloses the technique of analyzing content of the business meeting through machine learning, a technique of supporting a dialog in a business meeting, or the like, has not been studied. Here, in the dialog in the business meeting, or the like, there is a case where a question regarding the goods, a service, or the like, is presented from a customer, or the like. It can be assumed to automatically obtain candidates for a response to the question through a chatbot, a machine learning model like a large-scale language mode, or the like. However, to obtain an appropriate response, it is necessary to interpret the question while understanding flow and context of the conversation, which has not been studied in the related art. In this manner, the dialog support technique has room for improvement.

The present disclosure provides a dialog support method, an information processing device, and a non-transitory storage medium that improve a dialog support technique.

A dialog support method according to a first aspect of the present disclosure is a dialog support method to be executed by an information processing device. The dialog support method includes:
determining a topic based on speech data regarding a predetermined thing and a database regarding the predetermined thing;
extracting a question sentence from the speech data and generating a supplemental question sentence based on the question sentence and the topic during a period while the question sentence has been extracted; and
outputting a response to the supplemental question sentence.

In the dialog support method according to the first aspect of the present disclosure, outputting the response may include outputting a response obtained by inputting the supplemental question sentence to a language model.

In the dialog support method according to the first aspect of the present disclosure, the speech data may be speech data in a business meeting for selling the predetermined thing.

In the dialog support method according to the first aspect of the present disclosure, the question sentence may be a question asked by a customer in the business meeting, and the dialog support method may include determining whether the number of times that the same question as the question asked by the customer has been asked to a sales staff in the past is less than a predetermined number of times, in a case where it is determined that the number of times that the same question as the question asked by the customer has been asked to the sales staff in the past is less than the predetermined number of times, generating the supplemental question sentence and outputting a response to the supplemental question sentence, and in a case where it is determined that the number of times that the same question as the question asked by the customer has been asked to the sales staff in the past is equal to or more than the predetermined number of times, neither generating the supplemental question sentence nor outputting the response to the supplemental question sentence.

In the dialog support method according to the first aspect of the present disclosure, the question sentence may be a question asked by a customer in the business meeting, and the dialog support method may include determining whether a sales staff starts responding to the question sentence within a predetermined period after the question sentence has been uttered, in a case where it is determined that the sales staff does not start responding to the question sentence within the predetermined period, generating the supplemental question sentence and outputting a response to the supplemental question sentence, and in a case where it is determined that the sales staff starts responding to the question sentence within the predetermined period, neither generating the supplemental question sentence nor outputting a response to the supplemental question sentence.

In the dialog support method according to the first aspect of the present disclosure, the question sentence may be a question asked by a customer in the business meeting, and the dialog support method may include estimating a tension degree of a sales staff during a period while the question sentence has been extracted, in a case where the tension degree is equal to or higher than a threshold, generating the supplemental question sentence and outputting a response to the supplemental question sentence, and in a case where the tension degree is less than the threshold, neither generating the supplemental question sentence nor outputting a response to the supplemental question sentence.

In the dialog support method according to the first aspect of the present disclosure, the question sentence may be a question asked by a sales staff, and the dialog support method may include determining whether a customer in the business meeting responds to the question sentence within a predetermined period after the question sentence has been uttered, in a case where it is determined that the customer does not respond to the question sentence within the predetermined period, generating the supplemental question sentence and outputting a response to the supplemental question sentence, and in a case where it is determined that the customer responds to the question sentence within the predetermined period, neither generating the supplemental question sentence nor outputting a response to the supplemental question sentence.

An information processing device according to a second aspect of the present disclosure is an information processing device including a control unit. The control unit is configured to determine a topic based on speech data regarding a predetermined thing and a database regarding the predetermined thing, extract a question sentence from the speech data and generate a supplemental question sentence based on the question sentence and the topic during a period while the question sentence has been extracted, and output a response to the supplemental question sentence.

A non-transitory storage medium according to a third aspect of the present disclosure stores instructions that are executable by a computer and that cause the computer to perform functions including: determining a topic based on speech data regarding a predetermined thing and a database regarding the predetermined thing; extracting a question sentence from the speech data and generating a supplemental question sentence based on the question sentence and the topic during a period while the question sentence has been extracted; and outputting a response to the supplemental question sentence.

According to the dialog support method, the information processing device, and the non-transitory storage medium according to the above-described aspects, a dialog support technique is improved.

### BRIEF DESCRIPTION OF THE DRAWINGS

Features, advantages, and technical and industrial significance of exemplary embodiments of the present disclosure will be described below with reference to the accompanying drawings, in which like signs denote like elements, and wherein:

FIG. 1 is a block diagram illustrating a schematic configuration of a system according to the present embodiment;

FIG. 2 is a flowchart indicating operation of an information processing device according to the present embodiment;

FIG. 3 is a flowchart indicating operation of an information processing device according to Modification 1;

FIG. 4 is a flowchart indicating operation of an information processing device according to Modification 2;

FIG. 5 is a flowchart indicating operation of an information processing device according to Modification 3; and

FIG. 6 is a flowchart indicating operation of an information processing device according to Modification 4.

### DETAILED DESCRIPTION OF EMBODIMENTS

An embodiment of the present disclosure will be described below.

### Outline of Embodiment

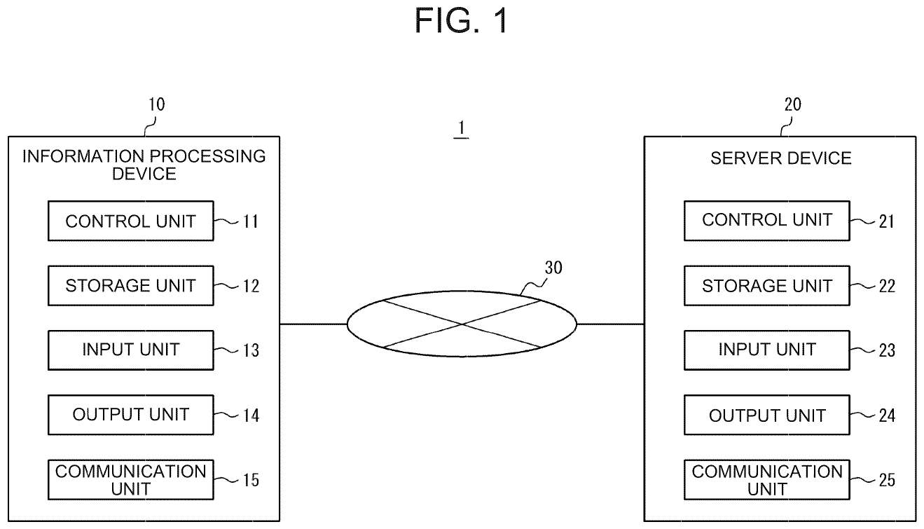

Outline and a configuration of a system 1 according to the present embodiment will be described with reference to FIG. 1. The system 1 according to the present embodiment includes an information processing device 10 and a server device 20. The information processing device 10 and the server device 20 are, for example, communicably connected to a network 30 including a mobile communication network, the Internet, and the like.

The information processing device 10 is an arbitrary device to be used by a staff in a business meeting, and the like. For example, general-purpose electronic equipment such as a personal computer, a smartphone, a tablet terminal, and a wearable terminal, or dedicated electronic equipment can be employed as the information processing device 10. Note that while FIG. 1 illustrates an example where the system 1 includes one information processing device 10, the number of the information processing devices 10 is not limited to this. The system 1 may include two or more information processing devices 10.

The server device 20 is, for example, a server device provided in a data center, or the like. For example, the server device 20 is a server belonging to a cloud computing system or other computing systems. The server device 20 can communicate with the information processing device 10 via the network 30. The server device 20 includes a language model. In the present embodiment, the language model includes an arbitrary dialog system such as, for example, a large language model (LLM) and a chatbot. The language model outputs text, or the like, corresponding to a prompt based on input of the prompt. For example, the information processing device 10 inputs the prompt to the language model of the server device 20 and acquires an output result corresponding to the prompt. Note that while FIG. 1 illustrates an example where the system 1 includes one server device 20, the number of the server devices 20 is not limited to this. The system 1 may include two or more server devices 20.

First, outline of a dialog support technique according to the present embodiment will be described, and details will be described later. The dialog support technique according to the present embodiment can be used in, for example, a business meeting, and the like. For example, the business meeting may be a meeting, or the like, for the purpose of conclusion of various kinds of contracts, such as sales of a vehicle, sales of real estate, contracts of insurance products, and sales of financial products. Further, a predetermined thing in the present embodiment may include an item provided in the business meeting, or the like. For example, the predetermined thing may be a product such as a vehicle, a service, digital content, license, data/information, financial products, real estate, intangible assets, other tradable rights, or the like.

The information processing device 10 determines a topic based on speech data regarding the predetermined thing and a database regarding the predetermined thing. Further, the information processing device 10 extracts a question sentence from the speech data and generates a supplemental question sentence based on the question sentence and the topic during a period while the question sentence has been extracted. Then, the information processing device 10 outputs a response to the supplemental question sentence.

In this manner, according to the present embodiment, the information processing device 10 determines the topic, automatically generates a response while supplementing the question in the conversation based on the determined topic, and outputs the response. Thus, the supplemental question sentence can be generated while flow of the conversation is taken into account, and a response to the supplemental question sentence can be obtained, so that a dialog support technique is improved.

Configurations of the information processing device 10 and the server device 20 will be described in detail next.

### Configuration of Information Processing Device 10

As illustrated in FIG. 1, the information processing device 10 includes a control unit 11, a storage unit 12, an input unit 13, an output unit 14, and a communication unit 15.

The control unit 11 includes at least one processor, at least one dedicated circuit or a combination thereof. The processor is a general-purpose processor such as a central processing unit (CPU) or a graphics processing unit (GPU) or a dedicated processor dedicated to specific processing. The dedicated circuit is, for example, a field-programmable gate array (FPGA) or an application specific integrated circuit (ASIC). The control unit 11 executes processing regarding operation of the information processing device 10 while controlling respective units of the information processing device 10.

The storage unit 12 includes at least one semiconductor memory, at least one magnetic memory, at least one optical memory, or a combination of at least two types among them. The semiconductor memory is, for example, a random access memory (RAM) or a read only memory (ROM). The RAM is, for example, a static random access memory (SRAM) or a dynamic random access memory (DRAM). The ROM is, for example, an electrically erasable programmable read only memory (EEPROM). The storage unit 12 functions as, for example, a main storage device, an auxiliary storage device or a cache memory. The storage unit 12 stores data to be used for operation of the information processing device 10 and data obtained by the operation of the information processing device 10.

Specifically, for example, the storage unit 12 may store the database regarding the predetermined thing. The database regarding the predetermined thing may include, for example, dictionary data of names related to the predetermined thing, specialized terminology, technical terms, instructions, manuals, and the like. The dictionary data may include a list of detailed definitions of terms specialized in a specific industry or technical field, related abbreviated words, synonymous words and similar words. Further, the dictionary data may include usage examples, context, a range of application, and the like, of each term. By this means, accurate information can be efficiently provided. More specifically, when the predetermined thing is a specific vehicle, the database may include main specifications such as names related to the vehicle, a model, an installed engine, an electric motor, fuel economy performance, a vehicle size, a weight, loaded functions, and options. Further, in this case, the database may include detailed information such as seat arrangement inside the vehicle, a level of the automated driving technique, a sensor technique, a battery type, a capacity, operation instructions, and manuals related to maintenance. The database regarding the predetermined thing may be regularly updated in accordance with technical innovation and industry trends and may reflect content in accordance with a new technology and industry standards. By utilizing such a database, it is possible to provide a base for allowing communication to smoothly proceed.

The input unit 13 includes at least one input interface. The input interface is, for example, a physical key, a capacitive key, a pointing device, or a touch screen integrally provided with a display. Further, the input interface may be, for example, a speech sensor that accepts a speech input or a camera, or the like, that accepts a gesture input. The input unit 13 accepts operation of inputting data to be used for the operation of the information processing device 10. The input unit 13 may be connected to the information processing device 10 as external input equipment instead of being provided in the information processing device 10. As a connection scheme, for example, an arbitrary scheme such as a universal serial bus (USB), a high-definition multimedia interface (HDMI) (registered trademark) or Bluetooth (registered trademark) can be used.

The output unit 14 includes at least one output interface. The output interface is, for example, a display that outputs information as a video, a speaker that outputs information as a speech, or the like. The display is, for example, a liquid crystal display (LCD) or an organic electroluminescence (EL) display. The output unit 14 outputs data obtained by the operation of the information processing device 10. The output unit 14 may be connected to the information processing device 10 as external output equipment instead of being provided in the information processing device 10. As a connection scheme, for example, an arbitrary scheme such as a USB, an HDMI (registered trademark) or Bluetooth (registered trademark) can be used.

The communication unit 15 includes at least one external communication interface. The communication interface may be an interface of either wired communication or wireless communication. In a case of wired communication, the communication interface is, for example, a local area network (LAN) interface or a universal serial bus (USB). In a case of wireless communication, the communication interface is, for example, an interface that supports mobile communication standards such as long term evolution (LTE), 4th generation (4G) or 5th generation (5G) or an interface that supports near field communication such as Bluetooth (registered trademark). The communication unit 15 receives data to be used for the operation of the information processing device 10 and transmits data obtained by the operation of the information processing device 10.

Functions of the information processing device 10 are implemented by a program according to the present embodiment being executed by a processor corresponding to the control unit 11. In other words, the functions of the information processing device 10 are implemented by software. The program causes a computer to function as the information processing device 10 by causing the computer to execute the operation of the information processing device 10. In other words, the computer functions as the information processing device 10 by executing the operation of the information processing device 10 in accordance with the program.

In the present embodiment, the program can be recorded in a computer-readable recording medium. The computer-readable recording medium includes a non-transitory computer-readable medium and is, for example, a magnetic recording device, an optical disk, a magnetooptical recording medium, or a semiconductor memory. The program is distributed by, for example, a portable recording medium such as a digital versatile disc (DVD) or a compact disc read only memory (CD-ROM), in which the program is recorded, being sold, given or lent. Further, the program may be distributed by being stored in a storage of an external server and transmitted to other computers from the external server. Still further, the program may be provided as a program product.

Some or all of the functions of the information processing device 10 may be implemented by a dedicated circuit corresponding to the control unit 11. In other words, some or all of the functions of the information processing device 10 may be implemented by hardware.

### Configuration of Server Device 20

As illustrated in FIG. 1, the server device 20 includes a control unit 21, a storage unit 22, an input unit 23, an output unit 24, and a communication unit 25.

The control unit 21 includes at least one processor, at least one dedicated circuit or a combination thereof. The processor is a general-purpose processor such as a central processing unit (CPU) or a graphics processing unit (GPU) or a dedicated processor dedicated to specific processing. The dedicated circuit is, for example, a field-programmable gate array (FPGA) or an application specific integrated circuit (ASIC). The control unit 21 executes processing regarding operation of the server device 20 while controlling respective units of the server device 20.

The storage unit 22 includes at least one semiconductor memory, at least one magnetic memory, at least one optical memory or a combination of at least two types among them. The semiconductor memory is, for example, a random access memory (RAM) or a read only memory (ROM). The RAM is, for example, a static random access memory (SRAM) or a dynamic random access memory (DRAM). The ROM is, for example, an electrically erasable programmable read only memory (EEPROM). The storage unit 22 functions as, for example, a main storage device, an auxiliary storage device or a cache memory. The storage unit 22 stores data to be used for the operation of the server device 20 and data obtained by the operation of the server device 20.

The input unit 23 includes at least one input interface. The input interface is, for example, a physical key, a capacitive key, a pointing device, or a touch screen integrally provided with a display. Further, the input interface may be, for example, a speech sensor that accepts a speech input or a camera, or the like, that accepts a gesture input. The input unit 23 accepts operation of inputting data to be used for the operation of the server device 20. The input unit 23 may be connected to the server device 20 as external input equipment instead of being provided in the server device 20. As a connection scheme, for example, an arbitrary scheme such as a universal serial bus (USB), a high-definition multimedia interface (HDMI) (registered trademark) or Bluetooth (registered trademark) can be used.

The output unit 24 includes at least one output interface. The output interface is, for example, a display that outputs information as a video, a speaker that outputs information as a speech, or the like. The display is, for example, a liquid crystal display (LCD) or an organic electroluminescence (EL) display. The output unit 24 outputs data obtained by the operation of the server device 20. The output unit 24 may be connected to the server device 20 as external output equipment instead of being provided in the server device 20. As a connection scheme, for example, an arbitrary scheme such as a USB, an HDMI (registered trademark) or Bluetooth (registered trademark) can be used.

The communication unit 25 includes at least one external communication interface. The communication interface may be an interface of either wired communication or wireless communication. In a case of wired communication, the communication interface is, for example, a local area network (LAN) interface or a universal serial bus (USB). In a case of wireless communication, the communication interface is an interface supporting mobile communication standards such as long term evolution (LTE), 4th generation (4G) or 5th generation (5G) or an interface supporting near field communication such as Bluetooth (registered trademark). The communication unit 25 receives data to be used for the operation of the server device 20 and transmits data obtained by the operation of the server device 20.

Functions of the server device 20 are implemented by the program according to the present embodiment being executed by a processor corresponding to the control unit 21. In other words, the functions of the server device 20 are implemented by software. The program causes a computer to function as the server device 20 by causing the computer to execute the operation of the server device 20. In other words, the computer functions as the server device 20 by executing the operation of the server device 20 in accordance with the program.

Some or all of the functions of the server device 20 may be implemented by a dedicated circuit corresponding to the control unit 21. In other words, some or all of the functions of the server device 20 may be implemented by hardware.

### Operation of Information Processing Device 10

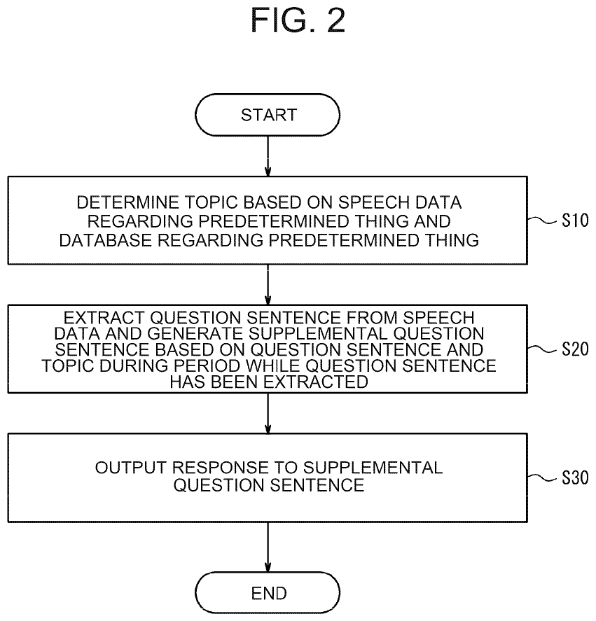

The operation of the information processing device 10 according to the present embodiment will be described with reference to FIG. 2. Here, an example will be mainly described where the speech data is, for example, speech data of a business meeting related to sales of a vehicle, and the predetermined thing is a specific vehicle.

Step S10: The control unit 11 of the information processing device 10 determines a topic based on speech data regarding a predetermined thing (here, a specific vehicle) and a database regarding the predetermined thing.

An arbitrary method can be employed for processing of acquiring the speech data. For example, the control unit 11 may acquire the speech data from an external device, or the like, via the communication unit 15 and the network 30. Further, for example, the control unit 11 may acquire the speech data via the input unit 13.

An arbitrary method can be employed for processing of determining the topic. For example, a machine learning algorithm, a technique of natural language processing (NLP) may be used to determine the topic. For example, the control unit 11 may analyze a keyword included in the speech data, content of the conversation based on the speech data, and the like, in real time by utilizing the database regarding the predetermined thing and determine the topic in each period of the speech data based on the analysis result. Specifically, the control unit 11 can extract a characteristic word and phrase from the speech data and determine the topic in consideration of appearance frequencies of these word and phrase, and context. A topic model (such as, for example, Latent Dirichlet Allocation and BERT) learned in advance may be used to determine the topic.

Step S20: The control unit 11 extracts a question sentence from the speech data and generates a supplemental question sentence based on the question sentence and a topic during a period while the question sentence has been extracted. An arbitrary method can be employed for processing of extracting the question sentence. The topic during a period while the question sentence has been extracted is specified based on the period while the question sentence has been extracted from the speech data and the topic determined in step S10.

An arbitrary method can be employed for processing of generating the supplemental question sentence. For example, the control unit 11 may generate the supplemental question sentence by determining interpretation of a term in the question sentence based on the term (such as an instruction word and a specific word) in the question sentence and the topic (such as a specific vehicle, a model, a function and an option) during a period while the question sentence has been extracted. In other words, the control unit 11 reconstructs the question sentence to a clearer form by supplementing the question sentence in which an instruction word, ambiguous expression, and the like, are used with specific content with reference to the topic, flow of the conversation, and the like. Specifically, for example, when the question sentence is “How much fuel consumption does this have?”, the control unit 11 may specify “this” in the question sentence as a specific vehicle type A based on the topic during a period while the question sentence has been extracted. Based on the determination, the control unit 11 may generate a supplemental question sentence of “How much fuel consumption does the specific vehicle type A have?”. Further, in the processing of generating the supplemental question sentence, attribute data of a speaker of the speech data may be used. The speaker of the speech data may be, for example, a customer or a sales staff. In other words, in the processing of generating the supplemental question sentence, attribute data of the customer, attribute data of the sales staff, or the like, may be used. The attribute data of the customer, the attribute data of the sales staff, or the like, may be, for example, stored in the storage unit 12, and the control unit 11 may generate the supplemental question sentence with reference to the attribute data of the customer, the attribute data of the sales staff, or the like, in the storage unit 12.

Step S30: The control unit 11 outputs a response to the supplemental question sentence.

The response to the supplemental question sentence can be generated using an arbitrary method. For example, the control unit 11 transmits a prompt including the supplemental question sentence to the server device 20 via the communication unit 15 and inputs the prompt to the language model of the server device 20. The language model of the server device 20 outputs a response to the prompt. The control unit 11 acquires the response via the communication unit 15. In this manner, the control unit 11 may generate the response to the supplemental question sentence by utilizing the language model of the server device 20. Note that the response to the supplemental question sentence may be generated by referring to customer data. For example, when content of the supplemental question sentence is a question regarding a size of a parking space of the customer, or the like, the control unit 11 may generate the response based on the customer data such as purchase history data and address data.

An arbitrary method can be employed for processing of outputting the response. For example, the control unit 11 may output the response through a user interface displayed and output by the output unit 14.

As described above, the information processing device 10 according to the present embodiment determines the topic based on the speech data regarding the predetermined thing and the database regarding the predetermined thing. Further, the information processing device 10 extracts the question sentence from the speech data and generates the supplemental question sentence based on the question sentence and the topic during a period while the question sentence has been extracted. Then, the information processing device 10 outputs the response to the supplemental question sentence. More specifically, even if utterance of a question “How much fuel consumption does this have?” asked by the customer during the business meeting for the specific vehicle type A can be extracted, if context is not understood, it is unclear what is indicated by a demonstrative pronoun “this”, and a response regarding “fuel consumption of the specific vehicle type A” cannot be obtained. Thus, the information processing device 10 according to the present embodiment can generate, as a result of having the above-described configuration, “How much fuel consumption does the specific vehicle type A have?” as the supplemental question sentence, and can output a response to the supplemental question sentence.

In this manner, the information processing device 10 determines a topic, automatically generates a response by supplementing the question during the conversation based on the determined topic, and outputs the response. Thus, the supplemental question sentence can be generated in consideration of flow of the conversation, and a response to the supplemental question sentence can be obtained, so that the dialog support technique is improved.

While the present disclosure has been described based on the drawings and examples, it should be noted that a person skilled in the art can make various modifications and alternations based on the present disclosure. It should be therefore noted that these modifications and alternations are included in the scope of the present disclosure. For example, functions, and the like, included in the components, the steps, and the like, can be rearranged such that there is no logical inconsistency, and a plurality of components, steps, and the like, can be combined to one, or can be divided.

For example, while the control unit 11 outputs the response to the supplemental question sentence in step S30 described above, the present disclosure is not limited to this. For example, the control unit 11 may output the supplemental question sentence instead of outputting the response to the supplemental question sentence. As a result of this, the supplemental question sentence in which flow of the conversation is taken into account is output, so that even when the question is ambiguous, an effect of supporting smooth proceeding of the conversation can be expected.

Further, for example, in the above-described embodiment, an embodiment is also possible where components and operation of the information processing device 10 are distributed to a plurality of computers which includes the server device 20 and which can perform communication with each other.

Further, for example, the information processing device 10 may execute switching processing as to whether to generate the supplemental question sentence and output the response to the supplemental question sentence. Specific examples of the switching processing will be described below as Modification 1 to Modification 4.

### Modification 1

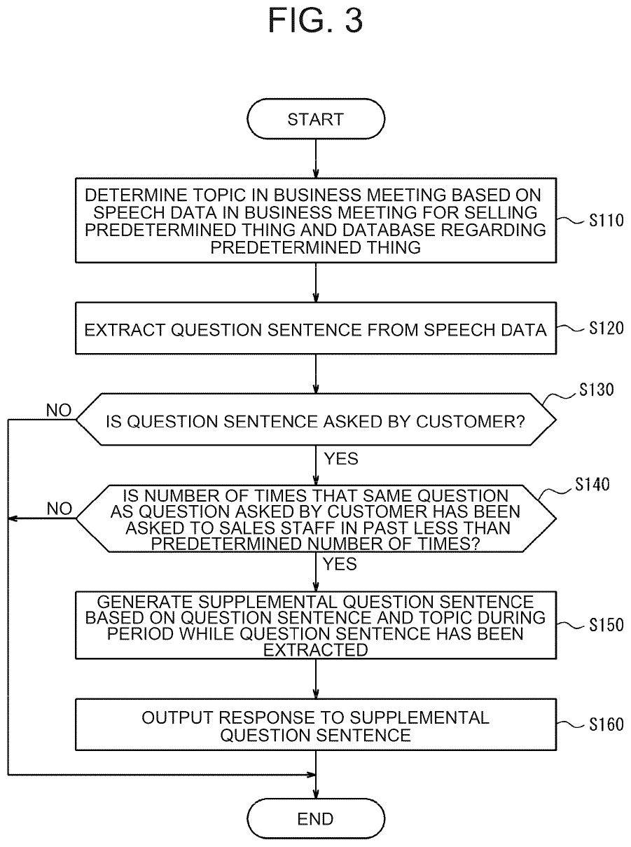

For example, the control unit 11 of the information processing device 10 may generate the supplemental question sentence based on the number of times that the question has been asked to the sales staff in the past business meeting and may output the response to the supplemental question sentence. FIG. 3 indicates operation of the information processing device 10 according to Modification 1.

Step S110: The control unit 11 of the information processing device 10 determines a topic in a business meeting based on speech data in the business meeting for selling a predetermined thing and a database regarding the predetermined thing. An arbitrary method can be employed for processing of acquiring the speech data and processing of determining the topic in a similar manner to the method described above in step S10.

Step S120: The control unit 11 extracts a question sentence from the speech data. An arbitrary method can be employed for processing of extracting the question sentence.

Step S130: The control unit 11 determines whether the question sentence is a question asked by the customer. An arbitrary method can be employed for the determination processing. For example, the control unit 11 may determine whether the question sentence is a question asked by the customer based on a feature amount (such as voice quality, a pitch, and an utterance speed of the speech) related to the speech data. In the determination processing, a machine learning model may be applied. When the question sentence is a question asked by the customer, the process proceeds to step S140. On the other hand, when the question sentence is not a question asked by the customer, the process ends.

Step S140: The control unit 11 determines whether the number of times that the same question as the question asked by the customer has been asked is less than a predetermined number of times among questions asked to the sales staff in the past. An arbitrary method can be employed for the determination processing. For example, the control unit 11 may execute the determination processing with reference to a database that stores history information of the questions asked to each sales staff. The database may be, for example, stored in the storage unit 12. When the number of times that the same question as the question asked by the customer has been asked is less than the predetermined number of times among the questions asked to the sales staff in the past, the process proceeds to step S150. On the other hand, when the number of times that the same question as the question asked by the customer has been asked is not less than the predetermined number of times among the questions asked to the sales staff in the past, the process ends.

Step S150: The control unit 11 generates a supplemental question sentence based on the question sentence and the topic during a period while the question sentence has been extracted. The topic during the period while the question sentence has been extracted is specified based on the period while the question sentence has been extracted from the speech data and the topic determined in step S110.

Step S160: The control unit 11 outputs a response to the supplemental question sentence. An arbitrary method can be employed for processing of acquiring the response to the supplemental question sentence and processing of outputting the response in a similar manner to the method described in step S10.

In this manner, in Modification 1, when the question sentence is a question asked by the customer in the business meeting, the control unit 11 determines whether the number of times that the same question has been asked to the sales staff in the past is less than the predetermined number of times. When it is determined that the number of times that the same question has been asked to the sales staff in the past is less than the predetermined number of times, the control unit 11 generates a supplemental question sentence and outputs a response to the supplemental question sentence. On the other hand, when it is determined that the number of times that the same question has been asked to the sales staff in the past is equal to or more than the predetermined number of times, the control unit 11 neither generates a supplemental question sentence nor outputs a response to the supplemental question sentence. By this means, for a question to which the sales staff has little experience of responding in the past business meetings, the response to the question is output. Further, for a question to which the sales staff has much experience of responding in the past business meetings, a response to the question is omitted, so that processing load of calculation processing, communication processing, and the like, by the information processing device 10 can be reduced, and convenience according to the present technology is improved.

### Modification 2

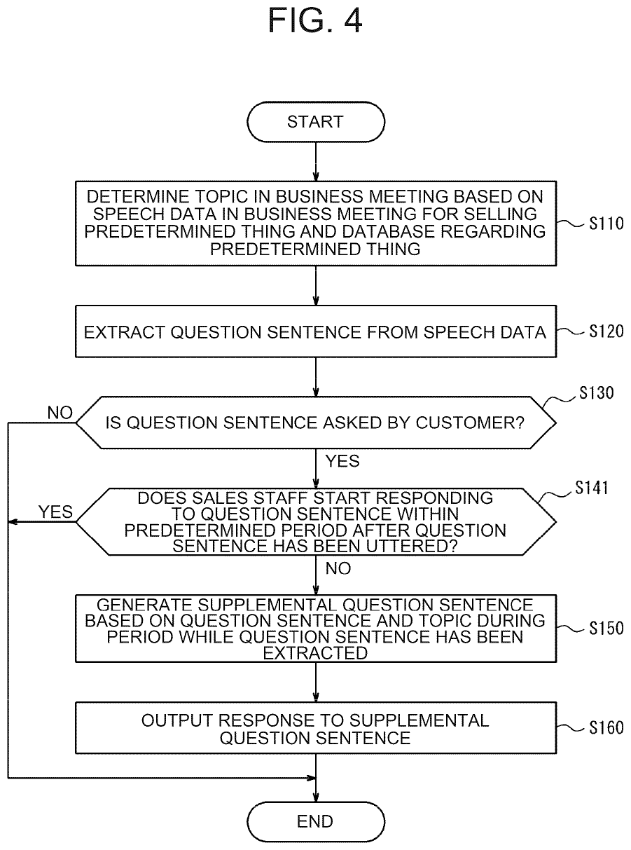

For example, as Modification 2, the control unit 11 of the information processing device 10 may generate a supplemental question sentence and output a response to the supplemental question sentence based on a period it takes sales staff to respond to the question sentence. FIG. 4 indicates operation of the information processing device 10 according to Modification 2. The same reference numerals will be assigned to operation that is the same as the operation in Modification 1, and description will be omitted.

Step S141: The control unit 11 of the information processing device 10 determines whether the sales staff starts responding to the question sentence within a predetermined period after the question sentence has been uttered. The predetermined period may be set as appropriate and may be, for example, three seconds, or the like. Further, different values may be determined for each sales staff as the predetermined period. When the sales staff starts responding to the question sentence within the predetermined period after the question sentence has been uttered, the process ends. On the other hand, when the sales staff does not start responding to the question sentence within the predetermined period after the question sentence has been uttered, the process proceeds to step S150.

In this manner, in Modification 2, when the question sentence is a question asked by the customer in the business meeting, the control unit 11 determines whether the sales staff starts responding to the question sentence within the predetermined period after the question sentence has been uttered. When it is determined that the sales staff does not start responding to the question sentence within the predetermined period after the question sentence has been uttered, the control unit 11 generates a supplemental question sentence and outputs a response to the supplemental question sentence. On the other hand, when it is determined that the sales staff starts responding to the question sentence within the predetermined period after the question sentence has been uttered, the control unit 11 neither generates a supplemental question sentence nor outputs a response to the supplemental question sentence. By this means, for a question to which the sales staff cannot instantly respond, a response to the question is output. Further, for a question to which the sales staff can instantly respond, a response to the question is omitted, so that processing load of calculation processing, communication processing, and the like, by the information processing device 10 can be reduced, and convenience according to the present technology is improved.

### Modification 3

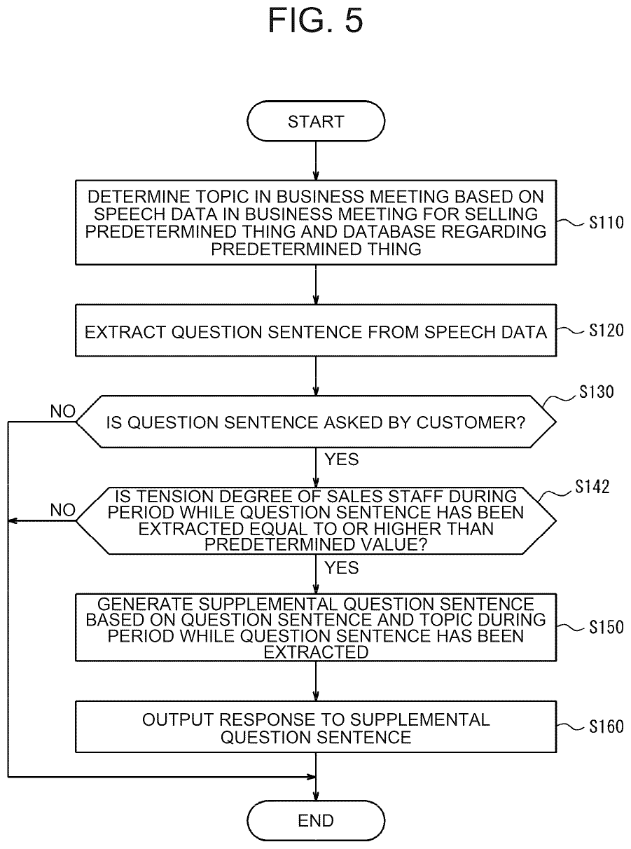

For example, as Modification 3, the control unit 11 of the information processing device 10 may generate a supplemental question sentence and output a response to the supplemental question sentence based on a tension degree of the sales staff. FIG. 5 indicates operation of the information processing device 10 according to Modification 3. The same reference numerals are assigned to operation that is the same as the operation in Modification 1, and description will be omitted.

Step S142: The control unit 11 of the information processing device 10 determines whether a tension degree of the sales staff during a period while the question sentence has been extracted is equal to or higher than a predetermined value. The tension degree of the sales staff during the period while the question sentence has been extracted may be estimated as appropriate through feeling estimation processing, or the like. In the feeling estimation processing, face image data of the sales staff may be used. In this case, the control unit 11 may acquire the face image data of the sales staff during the business meeting, for example, the face image data being captured by an external camera, or the like, and may estimate the tension degree of the sales staff based on the face image data. The predetermined value related to the tension degree may be set as appropriate. Further, different values may be determined for each sales staff as the predetermined value. Note that the tension degree may be estimated using a method other than the feeling estimation processing. For example, the tension degree may be estimated through estimation by a heart rate, estimation by a respiration rate, estimation by a body temperature, estimation by an opening degree of the pupil, and the like. When the tension degree of the sales staff during the period while the question sentence has been extracted is equal to or higher than the predetermined value, the process proceeds to step S150. On the other hand, when the tension degree of the sales staff during the period while the question sentence has been extracted is not equal to or higher than the predetermined value, the process ends.

In this manner, in Modification 3, when the question sentence is a question asked by the customer in the business meeting, the control unit 11 determines whether the tension degree of the sales staff during a period while the question sentence has been extracted is equal to or higher than the predetermined value. When it is determined that the tension degree of the sales staff during the period while the question sentence has been extracted is equal to or higher than the predetermined value, the control unit 11 generates a supplemental question sentence and outputs a response to the supplemental question sentence. On the other hand, when it is determined that the tension degree of the sales staff during the period while the question sentence has been extracted is not equal to or higher than the predetermined value, the control unit 11 neither generates a supplemental question sentence nor outputs a response to the supplemental question sentence. By this means, for a question to which the sales staff cannot respond as a result of being puzzled and getting tensed up, a response to the question is output. Further, for a question to which the sales staff can respond without being puzzled, a response to the question is omitted, so that processing load of calculation processing, communication processing, and the like, by the information processing device 10 can be reduced, and convenience according to the present technology is improved.

### Modification 4

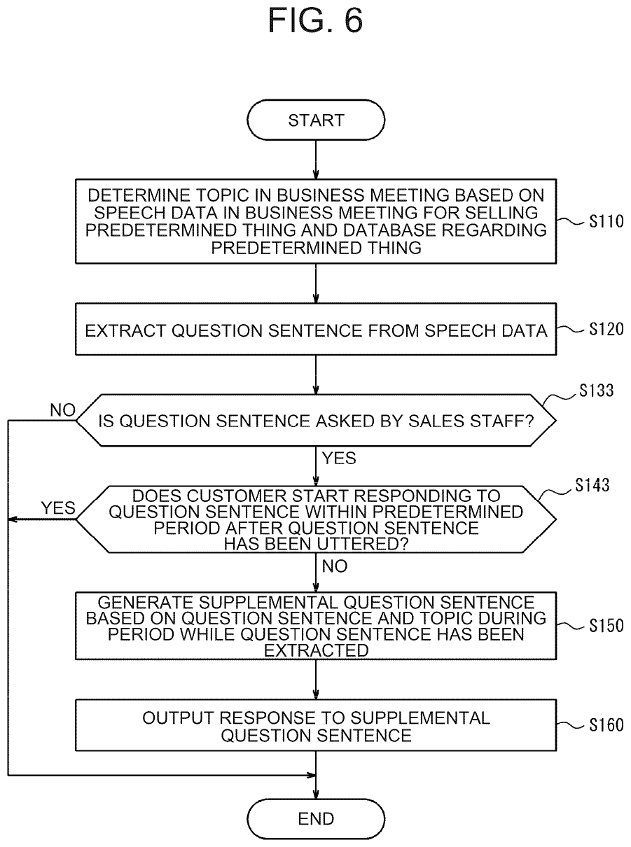

Further, for example, there is a case where the sales staff asks a question to the customer. Further, there can be a case where the question is a question to which it is difficult for the customer to respond. Thus, for example, as Modification 4, a supplemental question sentence to the question asked by the sales staff may be generated. FIG. 6 indicates operation of the information processing device 10 according to Modification 4. The same reference numerals are assigned to operation that is the same as the operation in Modification 1, and description will be omitted.

Step S133: The control unit 11 determines whether the question sentence is a question asked by the sales staff. An arbitrary method can be employed for the determination processing. For example, the control unit 11 may determine whether the question sentence is a question asked by the sales staff based on a feature amount (such as voice quality, a pitch and an utterance speed of the speech) related to the speech data. A machine learning model may be applied in the determination processing. When the question sentence is a question asked by the sales staff, the process proceeds to step S140. On the other hand, when the question sentence is not a question asked by the sales staff, the process ends.

Step S143: The control unit 11 of the information processing device 10 determines whether the customer starts responding to the question sentence within a predetermined period after the question sentence has been uttered. The predetermined period may be set as appropriate and may be, for example, three seconds, or the like. Further, different values may be determined for each customer as the predetermined period. When the customer starts responding to the question sentence within the predetermined period after the question sentence has been uttered, the process ends. On the other hand, when the customer does not start responding to the question sentence within the predetermined period after the question sentence has been uttered, the process proceeds to step S150.

In this manner, in Modification 4, when the question sentence is a question asked by the sales staff in the business meeting, the control unit 11 determines whether the customer starts responding to the question sentence within the predetermined period after the question sentence has been uttered. When it is determined that the customer does not start responding to the question sentence within the predetermined period after the question sentence has been uttered, the control unit 11 generates a supplemental question sentence and outputs a response to the supplemental question sentence. On the other hand, when it is determined that the customer starts responding to the question sentence within the predetermined period after the question sentence has been uttered, the control unit 11 neither generates a supplemental question sentence nor outputs a response to the supplemental question sentence. By this means, for a question to which the customer cannot instantly respond, a response to the question is output. This enables the sales staff to smoothly proceed with the business meeting by presenting the output response to the question to the customer as a response example, changing a way of questioning by changing the question, and the like. On the other hand, for a question to which the customer can instantly respond, a response to the question is omitted, so that processing load of calculation processing, communication processing, and the like, by the information processing device 10 can be reduced, and convenience according to the present technology is improved. Note that when the question sentence is a question asked by the sales staff in the business meeting, in step S160, a supplemental question sentence may be indicated instead of a response to the supplemental question sentence. The sales staff can smoothly proceed with the business meeting by changing a way of questioning by changing the question to the customer based on the supplemental question sentence.

Note that while when it is determined in step S133 the question sentence is not a question asked by the sales staff, the process ends, the present disclosure is not limited to this. In this case, the question sentence is a question asked by the customer, and thus, the control unit 11 may generate a supplemental question sentence for the question as appropriate and output a response to the supplemental question sentence.

Some of embodiments of the present disclosure will be exemplified below. However, it should be noted that embodiments of the present disclosure are not limited to these.

### Supplement 1

A dialog support method to be executed by an information processing device, the dialog support method including:
determining a topic based on speech data regarding a predetermined thing and a database regarding the predetermined thing;
extracting a question sentence from the speech data and generating a supplemental question sentence based on the question sentence and the topic during a period while the question sentence has been extracted; and
outputting a response to the supplemental question sentence.

### Supplement 2

The dialog support method according to Supplement 1,
in which outputting the response includes outputting a response obtained by inputting the supplemental question sentence to a language model.

### Supplement 3

The dialog support method according to Supplement 1 or 2,
in which the speech data is speech data in a business meeting for selling the predetermined thing.

### Supplement 4

The dialog support method according to Supplement 3, wherein
the question sentence is a question asked by a customer in the business meeting, and
the dialog support method includes:
determining whether the number of times that the same question as the question asked by the customer has been asked to a sales staff in the past is less than a predetermined number of times;
in a case where it is determined that the number of times that the same question as the question asked by the customer has been asked to the sales staff in the past is less than the predetermined number of times, generating the supplemental question sentence and outputting a response to the supplemental question sentence; and
in a case where it is determined that the number of times that the same question as the question asked by the customer has been asked to the sales staff in the past is equal to or more than the predetermined number of times, neither generating the supplemental question sentence nor outputting a response to the supplemental question sentence.

### Supplement 5

The dialog support method according to Supplement 3, wherein the question sentence is a question asked by a customer in the business meeting, and the dialog support method includes:
determining whether a sales staff starts responding to the question sentence within a predetermined period after the question sentence has been uttered;
in a case where it is determined that the sales staff does not start responding to the question sentence within the predetermined period, generating the supplemental question sentence and outputting a response to the supplemental question sentence; and
in a case where it is determined that the sales staff starts responding to the question sentence within the predetermined period, neither generating the supplemental question sentence nor outputting a response to the supplemental question sentence.

### Supplement 6

The dialog support method according to Supplement 3, wherein
the question sentence is a question asked by a customer in the business meeting, and
the dialog support method includes:
estimating a tension degree of a sales staff during a period while the question sentence has been extracted;
in a case where the tension degree is equal to or higher than a threshold, generating the supplemental question sentence and outputting a response to the supplemental question sentence; and
in a case where the tension degree is less than the threshold, neither generating the supplemental question sentence nor outputting a response to the supplemental question sentence.

### Supplement 7

The dialog support method according to Supplement 3, wherein
the question sentence is a question asked by a sales staff, and
the dialog support method includes:
determining whether a customer in the business meeting responds to the question sentence within a predetermined period after the question sentence has been uttered;
in a case where it is determined that the customer does not respond to the question sentence within the predetermined period, generating the supplemental question sentence and outputting a response to the supplemental question sentence; and
in a case where it is determined that the customer responds to the question sentence within the predetermined period, neither generating the supplemental question sentence nor outputting a response to the supplemental question sentence.

### Supplement 8

An information processing device including a control unit, wherein
the control unit is configured to:
determine a topic based on speech data regarding a predetermined thing and a database regarding the predetermined thing;
extract a question sentence from the speech data and generate a supplemental question sentence based on the question sentence and the topic during a period while the question sentence has been extracted; and
output a response to the supplemental question sentence.

### Supplement 9

A program causing a computer to execute:
determining a topic based on speech data regarding a predetermined thing and a database regarding the predetermined thing;
extracting a question sentence from the speech data and generating a supplemental question sentence based on the question sentence and the topic during a period while the question sentence has been extracted; and
outputting a response to the supplemental question sentence.

What is claimed is:

1. A dialog support method to be executed by an information processing device, the dialog support method comprising:
determining a topic based on speech data regarding a predetermined thing and a database regarding the predetermined thing;
extracting a question sentence from the speech data and generating a supplemental question sentence based on the question sentence and the topic during a period while the question sentence has been extracted; and
outputting a response to the supplemental question sentence.

2. The dialog support method according to claim 1, wherein outputting the response includes outputting a response obtained by inputting the supplemental question sentence to a language model.

3. The dialog support method according to claim 1, wherein the speech data is speech data in a business meeting for selling the predetermined thing.

4. The dialog support method according to claim 3, wherein
the question sentence is a question asked by a customer in the business meeting, and
the dialog support method comprises:
determining whether the number of times that the same question as the question asked by the customer has been asked to a sales staff in the past is less than a predetermined number of times;
in a case where it is determined that the number of times that the same question as the question asked by the customer has been asked to the sales staff in the past is less than the predetermined number of times, generating the supplemental question sentence and outputting a response to the supplemental question sentence; and
in a case where it is determined that the number of times that the same question as the question asked by the customer has been asked to the sales staff in the past is equal to or more than the predetermined number of times, neither generating the supplemental question sentence nor outputting a response to the supplemental question sentence.

5. The dialog support method according to claim 3, wherein
the question sentence is a question asked by a customer in the business meeting, and
the dialog support method comprises:
determining whether a sales staff starts responding to the question sentence within a predetermined period after the question sentence has been uttered;
in a case where it is determined that the sales staff does not start responding to the question sentence within the predetermined period, generating the supplemental question sentence and outputting a response to the supplemental question sentence; and
in a case where it is determined that the sales staff starts responding to the question sentence within the predetermined period, neither generating the supplemental question sentence nor outputting a response to the supplemental question sentence.

6. The dialog support method according to claim 3, wherein
the question sentence is a question asked by a customer in the business meeting, and
the dialog support method comprises:
estimating a tension degree of a sales staff during a period while the question sentence has been extracted;
in a case where the tension degree is equal to or higher than a threshold, generating the supplemental question sentence and outputting a response to the supplemental question sentence; and
in a case where the tension degree is less than the threshold, neither generating the supplemental question sentence nor outputting a response to the supplemental question sentence.

7. The dialog support method according to claim 3, wherein
the question sentence is a question asked by a sales staff, and
the dialog support method comprises:
determining whether a customer in the business meeting responds to the question sentence within a predetermined period after the question sentence has been uttered;
in a case where it is determined that the customer does not respond to the question sentence within the predetermined period, generating the supplemental question sentence and outputting a response to the supplemental question sentence; and
in a case where it is determined that the customer responds to the question sentence within the predetermined period, neither generating the supplemental question sentence nor outputting a response to the supplemental question sentence.

8. An information processing device, comprising
a control unit, wherein
the control unit is configured to:
determine a topic based on speech data regarding a predetermined thing and a database regarding the predetermined thing;
extract a question sentence from the speech data and generate a supplemental question sentence based on the question sentence and the topic during a period while the question sentence has been extracted; and
output a response to the supplemental question sentence.

9. A non-transitory storage medium storing instructions that are executable by a computer and that cause the computer to perform functions comprising:
determining a topic based on speech data regarding a predetermined thing and a database regarding the predetermined thing;
extracting a question sentence from the speech data and generating a supplemental question sentence based on the question sentence and the topic during a period while the question sentence has been extracted; and
outputting a response to the supplemental question sentence.
